(19) United States
(12) Patent Application Publication
(10) Pub. No.: US 2022/0324051 A1
(43) Pub. Date: Oct. 13, 2022

(54) ADAPTIVE FRICTION ELEMENT WELD PROCESS AND CONTROL

(71) Applicant: Ford Global Technologies, LLC, Dearborn, MI (US)

(72) Inventors: Garret Sankey Huff, Ann Arbor, MI (US); Amanda Kay Freis, Ann Arbor, MI (US)

(73) Assignee: Ford Global Technologies, LLC, Dearborn, MI (US)

(21) Appl. No.: 17/225,399

(22) Filed: Apr. 8, 2021

(51) Int. Cl. B23K 20/12

(52) U.S. Cl. CPC B23K 20/121

(57) ABSTRACT

A method of installing a friction element includes driving the friction element through a top panel and friction welding the friction element to a bottom panel. At least one additional panel may or may not be between the top panel and the bottom panel. Also, at least one key friction element weld (FEW) parameter is controlled during installing of the friction element, at least one key FEW parameter is monitored during installing of the friction element, and the at least one key FEW controlled parameter is adjusted in real-time as a function of and in response to the at least one key FEW monitored parameter exhibiting completion of at least one key FEW process characteristic. Non-limiting examples of the at least one key FEW controlled parameter include RPM of the friction element and insertion force applied to the friction element.

### FIELD

The present disclosure relates to friction welding, and particularly to friction element welding.

### BACKGROUND

The statements in this section merely provide background information related to the present disclosure and may not constitute prior art.

During assembly line manufacturing, a friction element weld (FEW) process can be an energy and cost efficient process to join dissimilar materials such as aluminum or aluminum alloys to steel. For example, and with reference to FIG. 1, an exemplary friction element weld process is illustrated through a series of progressive illustrations, in which a friction element 1 is rotated at high RPMs and applied with an axial force (also referred to herein as an “insertion force”) to an upper piece 2 and a lower piece 3. As the friction element 1 is rotated and the insertion force is applied, the materials of the upper and lower pieces 2/3 soften, thus allowing the friction element 1 to penetrate these pieces. When the head 4 of the friction element 1 abuts the upper piece 2, the rotation and axial force applied to the friction element 1 are removed, and then the materials of the upper and lower pieces 2/3 harden, or recrystallize, thus forming a mechanical connection between the friction element 1 and the upper and lower pieces 2/3 and a friction welded assembly 5. Such a fastening method can be efficient and economical in high production environments, such as the assembly of automotive body parts/panels. However, variations in the upper panels and/or the lower panels joined by the FEW process, e.g., variations in thickness, can result in variations in FEW joint performance.

The present disclosure addresses the issues of variations in panels being joined together via a FEW process, among other issues related to FEW processes.

### SUMMARY

This section provides a general summary of the disclosure and is not a comprehensive disclosure of its full scope or all of its features.

According to one form of the present disclosure, a method of installing a friction element includes driving the friction element through at least a top panel and welding the friction element to a bottom panel using a friction element weld (FEW) machine. Also. The method includes controlling at least one key FEW controlled parameter of the FEW machine during installation of the friction element, monitoring at least one key FEW monitored parameter of the FEW machine during installation of the friction element, and adjusting the at least one key FEW controlled parameter of the FEW machine in real-time as a function of and in response to the at least one key FEW monitored parameter exhibiting completion of at least one key FEW process characteristic such that the friction element is adaptively installed based on the adjusting of the at least one key FEW controlled parameter of the FEW machine. In some variations, the at least one key FEW controlled parameter is at least one of RPM of the friction element and applied insertion force on the friction element and the at least one key FEW monitored parameter is at least one of torque of an electric motor rotating the friction element, time during installation of the friction element, energy consumption during installation of the friction element, electric current of the electric motor during installation of the friction element, and electric current of a servo-motor during installation of the friction element.

In at least one variation, the driving and welding of the friction element comprises rotating, with an electric motor, and applying an insertion force to, with a servo-motor, a bit that is engaged with the friction element.

In some variations, the at least one key FEW characteristic is at least one of movement of the friction element shaft through the top panel, penetration of a distal end of the friction element through the top panel, cleaning debris from the bottom panel with the distal end of the friction element, removing a coating on an upper surface of the bottom panel with the distal end of the friction element, welding of the friction element to the bottom panel, and deformation of the friction element after welding during insertion.

In at least one variation, the method further includes comparing the at least one key FEW monitored parameter with at least one stored key FEW monitored parameter and adjusting the at least one key FEW controlled parameter in real-time as a function of the comparison. In such variations, the at least one stored key FEW monitored parameter can be provided from a remote database.

In some variations, the method further includes installing a plurality of friction elements and collecting and storing the at least one key FEW controlled parameter during the installation of the plurality of friction elements in a remote database.

In at least one variation the method further includes installing a plurality of friction elements and collecting and storing the at least one key FEW monitored parameter during the installation of the plurality of friction elements in a remote database.

In some variations, the method further includes generating an alert in response to the at least one key FEW monitored parameter signaling a failure to complete the at least one key FEW process characteristic. In such variations the at least one key FEW monitored parameter can include the torque not increasing during a predefined portion of the installation of the friction element.

In at least one variation, the method further includes generating an alert in response to the at least one key FEW monitored parameter signaling overfilling of an underhead of the friction element. In such variations the at least one key FEW monitored parameter signaling overfilling of an underhead of the friction element can include a spiked increase in energy consumption during installing of the friction element.

In some variations, the driving and friction welding of the friction element comprises rotating a bit engaged with the friction element with an electric motor and applying an insertion force onto the bit with a servo-motor and the at least one key FEW process characteristic comprises at least one of movement of the friction element shaft through the top panel, penetration of a distal end of the friction element through the top panel, cleaning debris from the bottom panel with the distal end of the friction element, removing a coating on an upper surface of the bottom panel with the distal end of the friction element, welding of the friction element to the bottom panel, and deformation of the friction element during insertion. In such variations the exhibiting completion of the at least one key FEW process characteristic can be a change in the torque and the RPM of the bit can be adjusted in real-time as a function of the change in torque. Also, the applied insertion force on the bit can be adjusted in real-time as a function as of the change in torque.

In another form of the present disclosure, a method of installing a friction element includes driving the friction element through at least a top panel and welding the friction element to a bottom panel using a FEW machine using an electric motor to rotate the friction element at one or more predefined RPMs and a servo-motor to apply one or more axial insertion forces to the friction element. The FEW machine controls at least one key FEW controlled parameter of the FEW machine during installation of the friction element and the at least one key FEW controlled parameter is at least one of RPM of the friction element and applied insertion force on the friction element. The FEW machine also monitors at least one key FEW monitored parameter of the FEW machine during installation of the friction element, and the at least one key FEW monitored parameter is at least one of torque of the electric motor rotating the friction element, time during installation of the friction element, energy consumption during installation the friction element, electric current of the electric motor during installation of the friction element, and electric current of the servo-motor during installation of the friction element. The FEW machine adjusts the at least one key FEW controlled parameter of the FEW machine in real-time as a function of and in response to the at least one key FEW monitored parameter exhibiting completion of at least one key FEW process characteristic such that the friction element is adaptively installed based on the adjusting of the at least one key FEW controlled parameter of the FEW machine, and generates an alert in response to the at least one key FEW monitored parameter signaling a failure to complete the at least one key FEW process characteristic.

In some variations, the method further includes generating an alert in response to the at least one key FEW monitored parameter signaling overfilling of an underhead of the friction element. And in such variations, the at least one key FEW monitored parameter signaling overfilling of an underhead of the friction element includes a spiked increase in energy consumption during installing of the friction element.

In still another form of the present disclosure, a method of installing a friction element includes driving the friction element through at least a top panel and welding the friction element to a bottom panel using a friction element weld (FEW) machine using an electric motor to rotate the friction element at one or more predefined RPMs and a servo-motor to apply one or more axial insertion forces to the restriction element. The method also includes controlling at least one key FEW controlled parameter of the FEW machine during installation of the friction element, monitoring at least one key FEW monitored parameter of the FEW machine during installation of the friction element, and adjusting the at least one key FEW controlled parameter of the FEW machine in real-time as a function of and in response to the at least one key FEW monitored parameter exhibiting completion of at least one key FEW process characteristic such that the friction element is adaptively installed based on the adjusting of the at least one key FEW controlled parameter of the FEW machine. The at least one key FEW controlled parameter is at least one of RPM of the friction element and applied insertion force on the friction element, and the at least one key FEW monitored parameter is at least one of torque of the electric motor rotating the friction element, time during installation of the friction element, energy consumption during installation the friction element, electric current of the electric motor during installation of the friction element, and electric current of the servo-motor during installation of the friction element. In some variations, the method includes generating an alert in response to the at least one key FEW monitored parameter signaling a failure to complete the at least one key FEW process characteristic, and/or generating an alert in response to the at least one key FEW monitored parameter signaling overfilling of an underhead of the friction element.

In at least one variation, the at least one key FEW monitored parameter signaling overfilling of an underhead of the friction element comprises a spiked increase in energy consumption during installing of the friction element.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a series of progressive cross-sectional views illustrating a friction welded structural assembly and a friction weld element/fastener according to the prior art;

FIG. 2A shows one step of a FEW process;

FIG. 2B shows another step of the FEW process;

FIG. 2C shows still another step of the FEW process;

FIG. 2D shows still yet another step of the FEW process;

FIG. 3A shows one type of variation during installing a friction element;

FIG. 3B shows another type of variation during installing a friction element;

FIG. 3C shows still another variation during installing a friction element;

FIG. 4 is an enlarged side cross-sectional view of the FEW joint in FIG. 2D and a functional block diagram of the adaptive system in FIGS. 2A-2D;

FIG. 5 is a graph of torque versus time and a graph of insertion force versus time for installing a friction element according to the teachings of the present disclosure;

FIG. 6 is flow chart for a method of installing a friction element according to the teachings of the present disclosure; and

FIG. 7 shows a system for installing friction elements according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

During installation of a friction element to form a FEW joint between panels, a number of different key parameters of the FEW process can be controlled and/or monitored. Such parameters include but are not limited to revolutions per minute (RPM) of the friction element, insertion force applied to the friction element, distance traveled by the friction element into the panels, torque of an electric motor rotating the friction element, time during installing the friction element, energy consumption during installing the friction element, electric current of the electric motor rotating the friction element, and electric current of a servo-motor applying the insertion force on the friction element, among others. Also, the FEW process can be characterized by different “stages” such as penetration and movement of the friction element through a panel (e.g., a top or upper panel), cleaning debris from a panel (e.g., a bottom or lower panel) with a distal end of the friction element (via rotation and friction), removing a coating from a panel with the distal end of the friction element, welding of the friction element to the bottom or lower panel, and compression or deformation of the friction element during insertion, among others.

The present disclosure provides a method of installing a friction element via the FEW process. The method accommodates or adjusts in real-time for variations in panels and/or panel assemblies being joined. As used herein, the term “real-time” refers to measuring, monitoring, and adjusting parameters of the FEW process within milliseconds (e.g., less than 20 milliseconds or less than 10 milliseconds) such that the friction element is adaptively installed based on the adjusting of the at least one KEY control parament of the FEW machine 100.

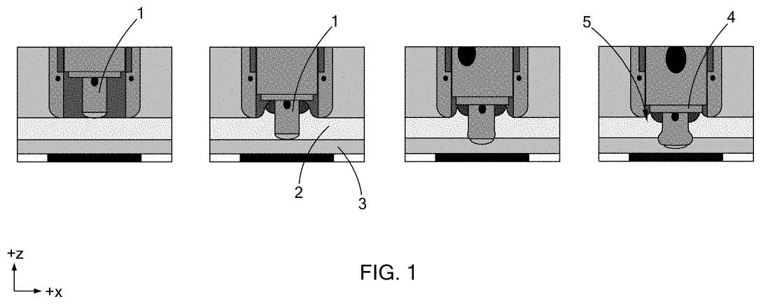

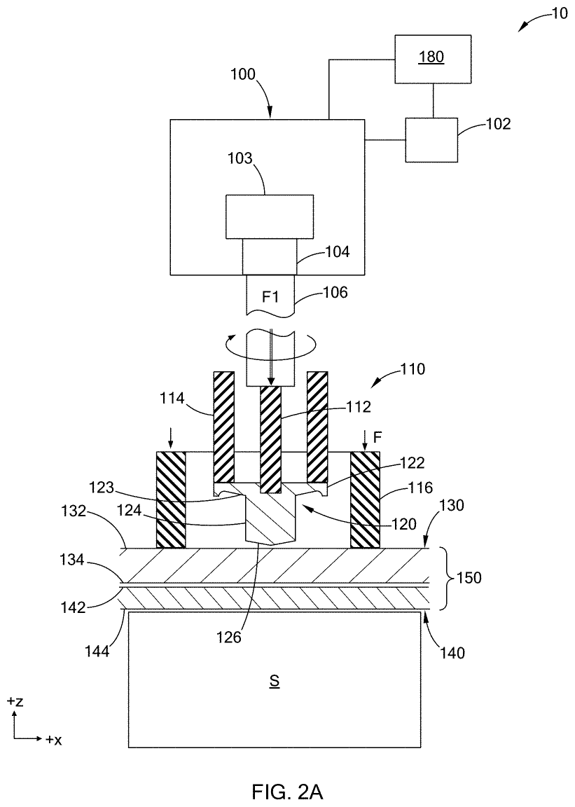

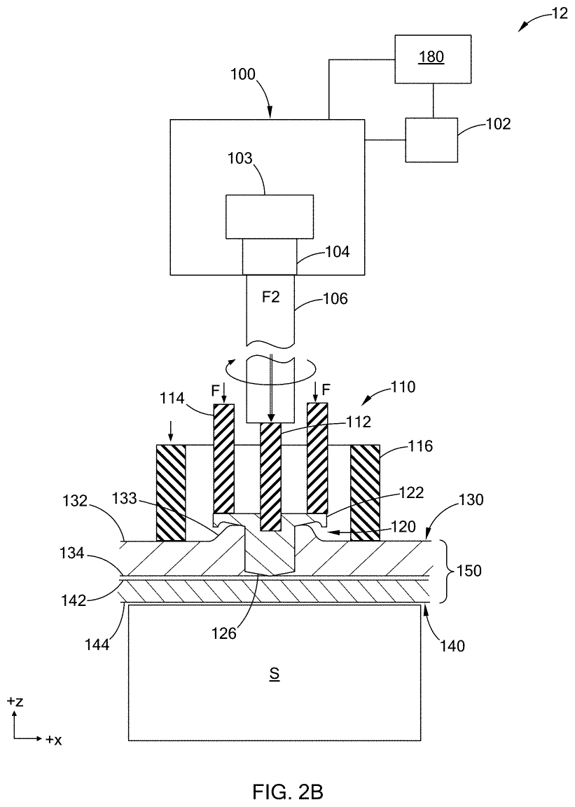

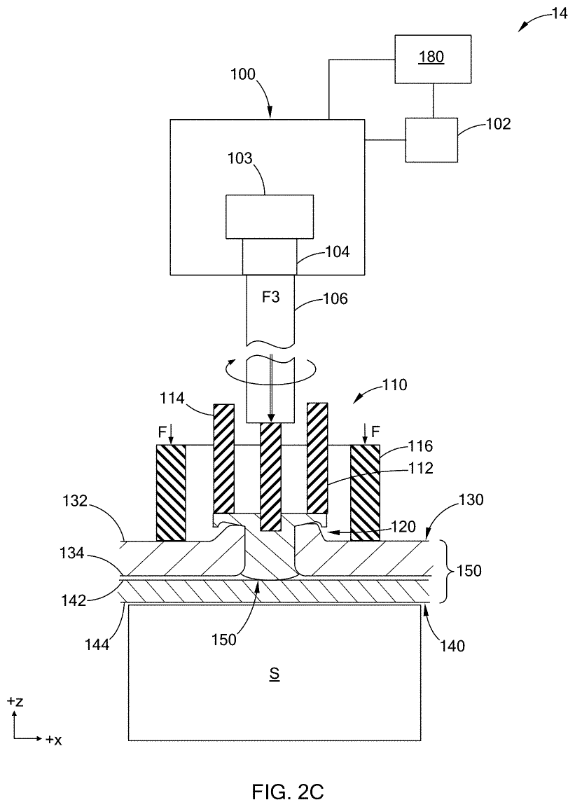

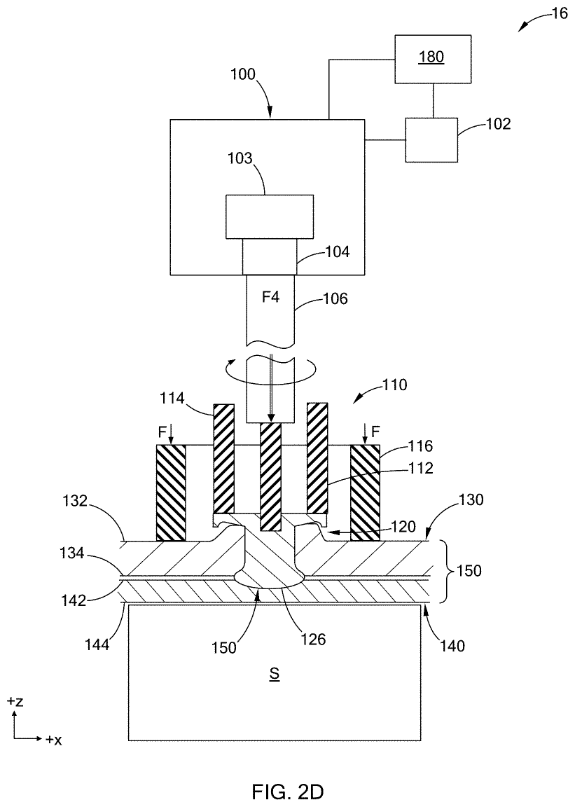

Referring now to FIGS. 2A-2D, steps 10-16 for installing a friction element 120 with a head 122, a shaft (or body) 124, and a distal end 126 are shown according to the teachings of the present disclosure. Particularly, FIG. 2A shows step 10 where a FEW machine 100 with a controller 102 and an electric motor 103 rotates a spindle 106 at a desired revolutions per minute (RPM), and a servo-motor 104 moves (z direction) or brings the distal end 126 of the friction element 120 into contact with an upper (+z direction) surface 132 of a top panel 130 of a panel assembly 150, and applies an insertion force ‘F1’ to the friction element 120 such that the distal end 126 penetrates and moves through the top panel 130 (FIG. 1B). That is, the FEW machine 100 with the controller 102, electric motor 103, and servo-motor 104 drives the friction element 120 through the top panel 130 of the panel assembly 150 via a combination of heat resulting from friction between the friction element 120 and the top panel 130 and the insertion force F1 applied to the friction element 120. And as shown in FIG. 2B, plastically deformed material 133 of the top panel 130 moves or accumulates under or beneath the head 122 of the friction element 120. Penetration and movement of the friction element 120 through the top panel 130 is referred to herein as “stage I” of the FEW process and in some variations is considered a key FEW process characteristic.

The controller 102 controls an operation of the FEW machine 100, and in some variations an adaptive system 180 for adapting or adjusting the FEW machine 100 before, during and/or after installation for a given friction element 120 and/or a given top panel 130—bottom panel 140 assembly is included.

It should be understood that the friction element 120 is driven (i.e., rotated and moved downwardly with or by the insertion force) by a friction element driver 110 that is rigidly engaged with the spindle 106 and the friction element 120. Particularly, the friction element driver 110 includes a bit 112 and a head support 114 configured to mechanically engage and support the head 122 of the friction element 120 such that the friction element 120 rotates with the spindle 106. Also, the head 122 can include an underhead 123 configured to accept or gather the plastically deformed material 133 from the top panel 130 as shown in FIGS. 1B-1D and 2. It should also be understood that key parameters of the FEW process are controlled and/or monitored during stage I and other stages and key FEW process characteristics discussed below. Key parameters of the FEW process that are controlled during installation of a friction element 120 are referred to herein as “key FEW controlled parameters” (i.e., configured to be controlled and adjusted in real-time) and key parameters of the FEW process that are monitored during installation of a friction element 120 are referred to herein as “key FEW monitored parameters” (i.e., configured for monitoring and not controlling or adjusting in real-time). In some variations one or more key FEW parameters are key FEW controlled parameters during installation of one or more friction elements 120 and then the same one or more key FEW parameters are key FEW monitored parameters during installation of one or more different friction elements 120. Similarly, in some variations one or more key FEW parameters are key FEW monitored parameters during installation of one or more friction elements 120 and then the same one or more key FEW parameters are key FEW controlled parameters during installation of one or more different friction elements 120.

The top panel 130 has a lower surface 134 and is disposed over a bottom (−z direction) panel 140 with an upper surface 142 and a lower surface 144. Also, the top panel 130 and the bottom panel 140 are supported by a support ‘S’ and a downholder 116 applies a downward (−z direction) stabilizing or clamping force ‘F’ onto the top panel 130 to inhibit vibration of the top panel 130 and the bottom panel 140 during installation of the friction element 120.

In some variations, the top panel 130 is a light metal or a light metal alloy such as magnesium, aluminum, titanium, and alloys thereof, among others. In such variations the bottom panel 140 can be a heavier metal or heavier metal alloy such as cast iron, steel, stainless steel, copper, and copper alloys, among others. In at least one variation the top panel 130 is an aluminum alloy and the bottom panel is a steel, e.g., an advanced high-strength steel. It should be understood that in such variations the friction element 120 can be formed from a steel. In other variations, the top panel 130 is a heavier metal or heavier metal alloy and the bottom panel 140 is a light metal or a light metal alloy. It should be understood that in such variations the friction element 120 can be formed from a light metal or light metal alloy.

Non-limiting examples of a thickness (z direction) of the top panel 130 include thicknesses between about 0.5 millimeter (mm) and 4.0 mm and non-limiting examples of a thickness of the bottom panel 140 include thicknesses greater than or equal to about 1 mm. And while FIG. 1A (and FIGS. 1C-1D) shows the panel assembly having only two panels (i.e., top panel 130 and bottom panel 140), in some variations the method according to the teachings of the present disclosure installs a friction element into a panel assembly 150 with more than two panels. That is, in some variations the panel assembly 150 includes a top panel 130, a bottom panel 140, and one or more intermediate panels between the top panel 130 and the bottom panel 140. In such variations, non-limiting examples of a thickness of the assembled upper panels (i.e., excluding the bottom panel) include thicknesses between about 1.0 mm and 12.0 mm.

Referring to FIG. 2B, step 12 includes removal of debris between the top panel 130 and the bottom panel 140, and/or removal of a coating from the upper surface 142 of the bottom panel 140. A combination of rotation of the distal end 126 of the friction element 120 and an insertion force ‘F2’ (e.g., a cleaning force) applied to the friction element 120 generates heat between the distal end 126 and the upper surface 142 such that debris and/or a coating on the upper surface 142 is removed via heat (e.g., burning) and mechanical sweeping by the distal end 126 of the friction element 120. Removal of debris between the top panel 130 and the bottom panel 140, and/or removal of a coating from the upper surface 142 of the bottom panel 140 is referred to herein as “stage II” of the FEW process and in some variations is considered a key FEW process characteristic.

Referring to FIG. 2C, step 14 includes friction welding of the friction element 120 to the bottom panel 140. The combination of rotation of the distal end 126 of the friction element 120 in contact with the upper surface 142 of the bottom panel 140 and an insertion force ‘F3’ (e.g., a welding force) applied to the friction element 120, forms a weld 145 between the friction element 120 and the bottom panel 140. Forming of the weld 145 is referred to herein as “stage III” of the FEW process and in some variations is considered a key FEW process characteristic.

Referring to FIG. 2D, step 16 includes compression of the friction element 120 with an insertion force ‘F4’ (e.g., a compression force) during and/or after rotation of the friction element 120 is stopped. The compression force F4 reduces or closes any defects that may have formed when friction element 120 stops rotating and enhances or ensures full seating of the head 122 of the friction element 120 against the top panel 130 such that a desired FEW joint 160 is provided. Compression of the friction element 120 such that the defects are reduced or closed and the head 122 is fully seated against the top panel 130 is referred to herein as “stage IV” and in some variations is considered a key FEW process characteristic.

As noted above, a plurality of parameters define installation of a given friction element 120 with non-limiting examples of key FEW parameters including RPM of the friction element 120 during stage I, II, III, and/or IV (referring to herein as “stages I-IV”), insertion force applied to the friction element 120 during stages I-IV, distance traveled (−z direction) by the friction element 120 during stages I-IV, torque of the electric motor 103 rotating the friction element 120 during stages I-IV, time during stages I-IV, energy consumption (also known as “process energy”) during stages I-IV, electric current of the electric motor 103 rotating the friction element 120 during stages I-IV, and electric current of the servo-motor 104 applying the insertion force on the friction element 120 during stages I-IV.

Each of the stages I-IV is executed controlling and monitoring one or more key FEW parameters of the FEW machine 100. For example, in some variations, the controller 102 directs the FEW machine 100 to execute a first RPM and a first target insertion force during stage I, a second RPM and a second target insertion force during stage II, a third RPM and a third target insertion force during stage III, and a fourth RPM and a fourth target insertion force during stage IV. In some variations, the parameters are the same during different stages, while in other variations the parameters are different during different stages.

In some variations of the present disclosure, torque is monitored (i.e., torque is a key FEW monitored parameter) and key FEW parameters such as RPM of the friction element 120 and/or insertion force applied to the friction element 120 are controlled and adjusted in real-time (i.e., RPM and insertion force are key FEW controlled parameters) during installing of the friction element 120. And in at least one variation, such key FEW controlled parameters are adjusted in real-time as a function of and in response to the torque exhibiting completion of a key FEW process characteristic has occurred.

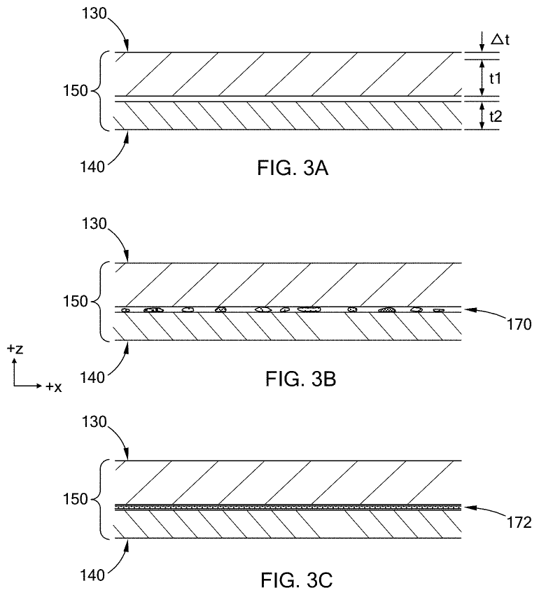

Referring to FIGS. 3A-3C, non-limiting examples of variations (also referred to herein as “variables”) that can be present during installation of friction elements 120 into panels of a panel assembly 150 are shown. Particularly, FIG. 3A shows a variation in the thickness ‘Δt’ between different top panels 130. That is, the top panel 130 typically has a designed or desired thickness ‘t1’, however top panels 130 are typically supplied with a thickness that is within a predefine tolerance (e.g., +/−Δt) of the thickness t1. Accordingly, the thickness of the top panels 130 typically varies between (t1-Δt) and (t1+Δt). Non-limiting examples of thickness t1 include 2.5 to 3.0 mm and non-limiting examples of the tolerance Δt include −0.2/+04 mm, +/−0.3 mm, and +/−0.5 mm.

Referring to FIG. 3B, debris 170 may be present between the top panel 130 and the bottom panel 140 during installation of a friction element 120. Non-limiting examples of the debris include dirt, sand, oil, grease, lubricant, moisture, paint, among others. It should be understood that the debris 170 alters the distance between the upper surface 132, and the lower surface 134, of the top panel 130 and the upper surface 142 of the bottom panel 140. In addition, the debris 170 may alter a friction coefficient between the distal end 126 of the friction element 120 and the upper surface 142 of the bottom panel 140.

Referring to FIG. 3C, a coating 172 may be present on the upper surface 142 of the bottom panel 140 and thus between the top panel 130 and the bottom panel 140. Non-limiting examples of the coating 172 include an aluminum-based coating, a zinc-based coating, among others. In addition, in some variations the coating 172 has a different chemical composition and/or thickness (z direction) between one set of bottom panels 140 (e.g., one lot or shipment of steel panels) and another set of bottom panels 140 (e.g., a second lot or shipment of steel panels). For example, one lot of bottom panels 140 assembled and joined with top panels 130 using the FEW process may have an aluminum-based coating 172 and another lot of bottom panels 140 assembled and joined with top panels 130 using the FEW process (e.g., using the same FEW machine 100) may have a zinc-based coating 172.

It should be understood that such variables during installation of friction elements 120 to form FEW joints 160 can result in variations in joint quality when process parameters are held constant during driving of the friction element 120 through the top panel 130 and welding the friction element 120 to the bottom panel 140. For example, traditional friction element welding systems typically control process parameters as a function of the height or depth (z direction) of the friction element 120 and/or the bit 112 during the FEW process. Accordingly, and given that thickness variations of the top panel 130, debris variations between the top panel 130 and the bottom panel 140, and/or coating variations of a coating on the bottom panel 140 can be present, monitoring and/or controlling installation friction elements 120 as a function of the friction element 120 and/or the bit 112 may not be desirable.

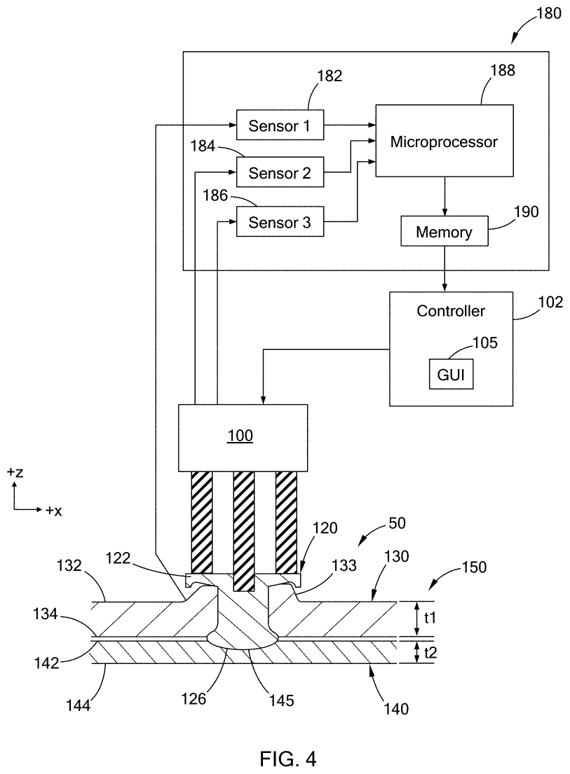

Referring to FIG. 4, an enlarged view of the FEW joint 160 and a functional block diagram of the adaptive system 180 is shown. The adaptive system 180 includes a plurality of sensors 182, 184, 186, a microprocessor 188, and memory 190. The adaptive system 180 is in communication with the controller 102 to provide one or more key FEW controlled parameters and/or one or more key FEW monitored parameters to the controller 102 to assist in operation of the FEW machine 100, taking into consideration the manufacturing/assembly tolerance of the panels of a panel assembly 150.

Generally, to join a panel assembly 150 together, a plurality of friction elements 120 are installed. In addition, the FEW machine 100 is used to install a plurality of friction elements 120 into a plurality of panel assemblies 150 being manufactured in an assembly line manufacturing facility. Moreover, the deformation of the top panel 130 (and any intermediate panels), and welding of the friction element 120 to the bottom panel 140, depend on the material properties of the friction element 120 and the panels of the panel assembly 150, amount of debris 170 between panels of a panel assembly 150, and variations of coatings 172 included in panel assemblies 150. Therefore, the material properties of the friction element 120 and the panels of the panel assembly 150, the thicknesses of the panels of the panel assembly 150, the amount of debris 170 that is present, and a coating 172 that may be present affect the robustness and quality of the FEW joints of the joined assemblies.

The plurality of sensors 182, 184, 186 are disposed at the FEW machine 100 and/or proximal to the panel assembly 150 for sensing and monitoring the operating conditions of the FEW machine 100 and/or conditions of the panel assembly 150 prior to, during, and after installation of the friction element 120. The operating conditions of the FEW machine 100 include the key FEW controlled parameters and the key FEW monitored parameters mentioned above, among others. For example, the plurality of sensors 182, 184, 186 may include a temperature sensor, a height (z direction) sensor, an RPM sensor, a torque sensor, an electric current sensor, and a time sensor, among others. The temperature sensor may be used to measure an in-situ temperature at a position near or proximal to the FEW joint 50 as it is being formed. The height sensor is used to measure a height of the bit 112 and thus a height of the head 122 and/or distal end of the friction element 120. The RPM sensor is used to measure an in-situ RPM of the bit 112 and thus an in-situ RPM of the friction element 120, the torque sensor is used to measure an in-situ torque of the electric motor 103 and thus a torque being applied to the friction element 120, and the current sensor is used to measure an in-situ current being drawn by or supplied to the electric motor 103 and/or the servo-motor 104. The time sensor is used to measure time during installation of the friction element 120 during stages I-IV.

The plurality of sensors 182, 184, 186 send signals corresponding to the various measurements to the microprocessor 188. The microprocessor 188 is configured to store, receive, calculate and send key FEW controlled parameters and/or key FEW monitored parameters to the controller 102 prior to, during, and/or after installation of the friction element 120 into the panel assembly 150. In some variations the microprocessor 188 stores the key FEW controlled parameters and/or key FEW monitored parameters in a memory 190 or a remote database (not shown). The controller 102 may be provided with the key FEW controlled parameters and/or key FEW monitored parameters wirelessly from the memory 190 or the remote database.

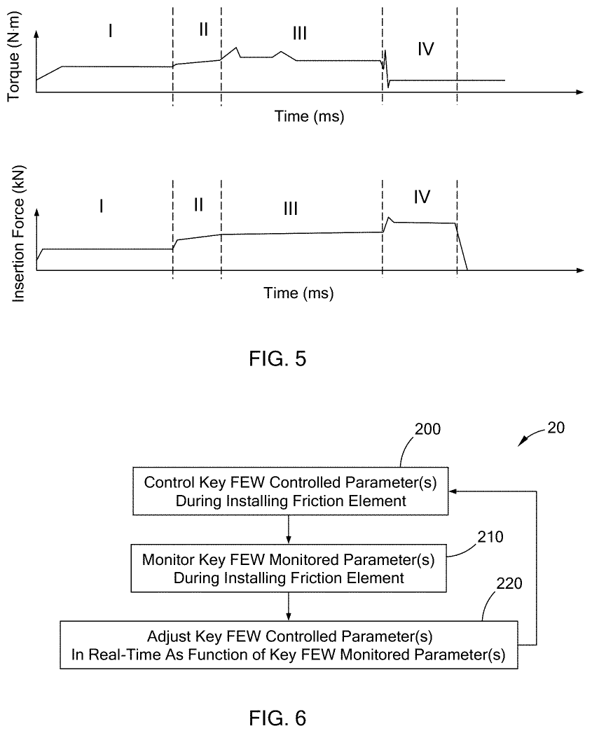

In some variations, to obtain one or more initial key FEW controlled parameters and/or key FEW monitored parameters, one or more trial installation processes may be performed so that the plurality of sensors 182, 184, 186 may obtain measurements of certain parameters prior to, during, and after the trial installation process. For example, and with reference to FIG. 5, two graphs are provided from a trial installation process or from an average of a plurality of trial installation processes in which a key FEW monitored parameter (torque—see top graph) was monitored and a key FEW controlled parameter (insertion force—see bottom graph) was controlled during successful installation of a friction element 120 or a plurality of friction elements 120.

As shown in FIG. 5, each stage during successful installation of a friction element 120 has a torque versus distance profile or “signature.” In addition, the completion of each stage exhibits a change in the torque. Particularly, the torque generally increases from a first level or plateau during stage I to a second higher level or plateau during stage II. In addition, initiation of stage III is exhibited by a spike (i.e., a rapid increase followed by a decrease) in the torque followed by another higher level or plateau (compared to stages I and II). And upon the onset of stage IV, the torque increases (e.g., spikes) and then decreases rapidly. Accordingly, for the example shown in FIG. 5, an increase in torque signals completion of stages I, II, and III. Also, monitoring of the torque via one or more of the plurality of sensors 182, 184, 186, and sending signals of the torque to the microprocessor 188 provides for the microprocessor 188 to determine if and when each of stages I-IV is completed and direct the controller 102 to control and adjust the insertion force accordingly. In at least one variation the torque versus distance signature and/or parts thereof is stored in the memory 190 for comparison with subsequent installations of friction elements 120 such that monitoring of the friction element installations is provided.

It should be understood that such monitoring provides for determination of various aspects of the installation process such as whether or not a successful friction element installation has occurred, gradual changes in one or more operation parameters during installing a plurality of friction elements 120, among others. For example, in some variations the monitoring of a key FEW monitored parameter signals that at least one of the key FEW process characteristics (e.g., stage I, II, III, and/or IV) has not been completed or successfully executed. And in such variations the microprocessor 188 is configured to generate an alert in response to such a signal (or lack thereof). In the alternative, or in addition to, the monitoring of a key FEW monitored parameter signals that an undesired event has occurred during installation of a friction element 120 (e.g., overfilling of an underhead 123 of the friction element). And in such variations the microprocessor 188 is configured to generate an alert in response to such a signal.

In some variations the measurements are sent to the microprocessor 188 for process and analysis in order to obtain an optimum installation result. Therefore, through the trial installation process, the controller 102 controls the FEW machine 100 to apply the friction element 120 with a predetermined RPM and insertion force suitable for the particular friction element 120 and the particular panel assembly 150, and monitors the torque for a signature of a successful installation result which is subsequently stored in the memory 190 and/or remote database. And in at least one variation, the trial installation process includes installation of a plurality of friction elements 120 using a plurality of RPMs and insertion forces with an analysis of which RPM and insertion force or which range of RPMs and/or range of insertion forces provide an optimum installation result. Also, the torques for successful installations and/or an average of the torques are subsequently stored in the memory 190 and/or remote database.

The controller 102 is in communication with the microprocessor 188 and FEW machine 100 for controlling the operation of the FEW machine 100 based on the key FEW controlled parameters and/or key FEW monitored parameters. The controller 102 then sets up the FEW machine 100 based on the parameters obtained during the trial processes (e.g., RPM and insertion force as a function of time or as a function of a given torque versus time signature) for an optimum FEW joint result. The controller 102 may adjust one or more key FEW controlled parameters of the FEW machine 100 based on one or more key FEW monitored parameters such that the friction element 120 is adaptively installed into the panel assembly 150.

During installation of the friction element 120, the various parameters are continuously obtained to provide a feedback to the controller 102, so that the controller 102 can control the FEW machine in a closed-loop manner, thereby achieving real time control of the process through sensed values. The feedback loop also monitors and tracks the installed friction element head height, thereby eliminating the need for a post-insertion checks. In addition, in some variations the microprocessor 188 and memory 190 include one or more algorithms configured to provide machine learning from the various parameters continuously obtained during operation of the FEW machine 100. Stated differently, the one or algorithms use the measurements from the trial installation process and/or subsequent successful installations of the friction elements 120 and build a model based on the measurements that make predictions and/or decisions related to present and future installations of the friction elements without being explicitly programmed to do so. Non-limiting examples of the one or more algorithms include supervised learning algorithms (e.g., nearest neighbor algorithm, Vaive Baye algorithm, decision trees algorithm, linear regression algorithm, support vector machine (SVM) algorithm, neural network algorithm) unsupervised learning algorithms (e.g., k-means clustering algorithm, association rules algorithm) semi-supervised algorithms, and reinforcement learning algorithms (e.g., Q-learning algorithm, temporal difference (TD) algorithm, deep adversarial network algorithm) among others.

The controller 102 may be a smart phone, a tablet, a laptop, and a personal computer. Alternatively, the controller 102 may integrated into the FEW machine 100 to assist in monitoring and storing signals from the various sensors 182, 184, 186. Optionally, the adaptive system 180 may include a graphical user interface (GUI) 52, which may be a separate component from the controller 102 and in communication with the controller 102, or which may reside within the controller 102.

Referring to FIG. 6, a method 20 according to the teachings of the present disclosure includes controlling one or more key FEW controlled parameters during installing of a friction element at 200, monitoring one or more key FEW monitored parameters during the installing of the friction element at 210, and adjusting one or more of the key FEW controlled parameters in real-time as a function of the one or more key FEW monitored parameters being monitored at 220. Also, the method 20 repeats this cycle 200, 210, 220 until the friction element is installed (e.g., stages I, II, III, and IV are complete). In some variations, the one or more key FEW controlled parameters is adjusted in real-time in response to the at least one key FEW monitored parameter exhibiting completion of at least one key FEW process characteristic (e.g., completion of stages I-IV). For example, in at least one variation the controller 102 includes memory 102m with a look-up table and the controller 102 selects one or more values for the one or more key FEW controlled parameters as function of one or more values of the at least one key FEW monitored parameter. In the alternative, or in addition to, the memory 102m includes an algorithm that calculates one or more values for the one or more key FEW controlled parameters as function of one or more values of the at least one key FEW monitored parameter.

In one example, and with reference back to FIG. 5, torque during the FEW process is a key FEW monitored parameter and insertion force is a key FEW controlled parameter. In addition, the insertion force is adjusted in real-time when the torque exhibits completion of stage I, stage II, and stage III. In this manner variables among stacks of panels (e.g., variations in thickness) to be joined with a FEW are accommodated for by the teachings of the present disclosure.

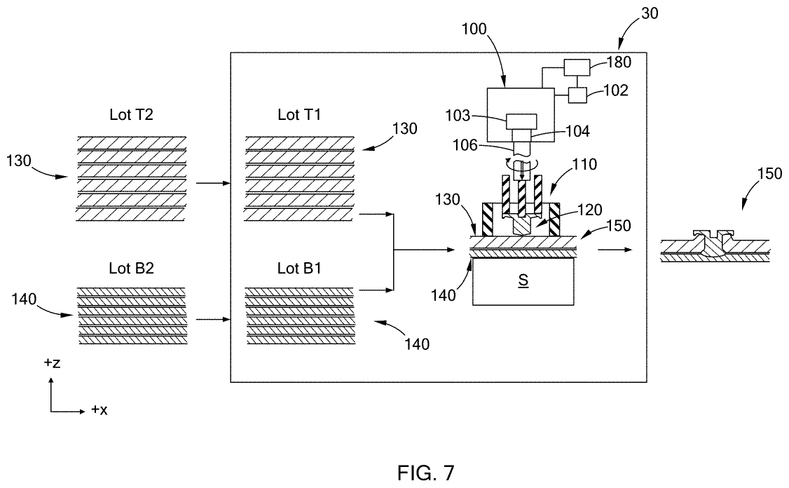

Referring to FIG. 7, a system 30 for installing friction elements according to the teachings of the present disclosure is shown. The system 30 includes the FEW machine 100 with the controller 102 and the adaptive system 180. In some variations the top panels 130 and the bottom panels 140 are provided as “lots” or “batches” of panels. Accordingly, and it should be understood, the top panels 130 and/or bottom panels 140 from different lots of panels can have one or more of the variations or variables discussed above. For example, a first lot T1 of top panels 130 and a first lot B1 of bottom panels 140 are used to form a plurality of assembled panels 150, followed by a second lot T2 of top panels 130 and/or a second lot B2 of bottom panels 140 used to form additional assembled panels 150.

In some variations, the top panels 130 from the first lot T1 compared to the top panels 130 of the second lot T2 have variations such as different thicknesses, different surface oxides, different surface oxide thicknesses, and/or a different surface film/lubricants, among others. Similarly, the bottom panels 140 from the first lot B1 compared to the bottom panels 140 form the second lot B2 have variations such as different coatings (e.g., Al—Si based coating or Zn based coating) and different surface film/lubricants, among others. And the amount of debris between a given top panel 130 and a given bottom panel 140 can vary from individual panel assemblies 150.

It should be understood that top panels 130 within a given lot can also have variations such as different thicknesses, different surface oxides, different surface oxide thicknesses, and different surface film/lubricants, among others. That is, variation between top panels 130 and bottom panels 140 can be present within a given lot of panels and between separate lots of panels. However, and unlike traditional FEW machines and/or systems that monitor such differences upstream from the FEW machine 100, the system 30 accommodates for such variations in real-time.

In some variations, the FEW machine 100 with the adaptive system 180 measures at least one key FEW parameter during stage I, stage II, stage III, and/or stage IV of the installation of at least one friction element 120 in a given panel assembly 150. In addition, the adaptive system 180 monitors stage I, stage II, stage III, and/or stage IV via at least one measured key FEW parameter and adjusts at least one of stage I, stage II, stage III, and/or stage IV as a function of the at least one key FEW parameter being measured.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of installing a friction element, the method comprising:
driving the friction element through at least a top panel and welding the friction element to a bottom panel using a friction element weld (FEW) machine;
controlling at least one key FEW controlled parameter of the FEW machine during installation of the friction element, wherein the at least one key FEW controlled parameter is at least one of RPM of the friction element and applied insertion force on the friction element;
monitoring at least one key FEW monitored parameter of the FEW machine during installation of the friction element, wherein the at least one key FEW monitored parameter is at least one of torque of an electric motor rotating the friction element, time during installation of the friction element, energy consumption during installation of the friction element, electric current of the electric motor during installation of the friction element, and electric current of a servo-motor during installation of the friction element; and
adjusting the at least one key FEW controlled parameter of the FEW machine in real-time as a function of and in response to the at least one key FEW monitored parameter exhibiting completion of at least one key FEW process characteristic such that the friction element is adaptively installed based on the adjusting of the at least one key FEW controlled parameter of the FEW machine.

2. The method according to claim 1, wherein the driving and welding of the friction element comprises rotating, with an electric motor, and applying an insertion force to, with a servo-motor, a bit that is engaged with the friction element.

3. The method according to claim 1, wherein the at least one key FEW characteristic is at least one of movement of a friction element shaft through the top panel, penetration of a distal end of the friction element through the top panel, cleaning debris from the bottom panel with the distal end of the friction element, removing a coating on an upper surface of the bottom panel with the distal end of the friction element, welding of the friction element to the bottom panel, and deformation of the friction element after welding during insertion.

4. The method according to claim 1 further comprising comparing the at least one key FEW monitored parameter with at least one stored key FEW monitored parameter and adjusting the at least one key FEW controlled parameter in real-time as a function of the comparison.

5. The method according to claim 4, wherein the at least one stored key FEW monitored parameter is provided from a remote database.

6. The method according to claim 1 further comprising installing a plurality of friction elements and collecting and storing the at least one key FEW controlled parameter during the installation of the plurality of friction elements in a remote database.

7. The method according to claim 1 further comprising installing a plurality of friction elements and collecting and storing the at least one key FEW monitored parameter during the installation of the plurality of friction elements in a remote database.

8. The method according to claim 1 further comprising generating an alert in response to the at least one key FEW monitored parameter signaling a failure to complete the at least one key FEW process characteristic.

9. The method according to claim 8, wherein the at least one key FEW monitored parameter comprises the torque not increasing during a predefined portion of the installation of the friction element.

10. The method according to claim 1 further comprising generating an alert in response to the at least one key FEW monitored parameter signaling overfilling of an underhead of the friction element.

11. The method according to claim 10, wherein the at least one key FEW monitored parameter signaling overfilling of an underhead of the friction element comprises a spiked increase in energy consumption during installing of the friction element.

12. The method according to claim 1, wherein:
the driving and friction welding of the friction element comprises rotating a bit with an electric motor and applying an insertion force onto the bit with a servo-motor, wherein the bit is engaged with the friction element, and
the at least one key FEW process characteristic comprises at least one of movement of a friction element shaft through the top panel, penetration of a distal end of the friction element through the top panel, cleaning debris from the bottom panel with the distal end of the friction element, removing a coating on an upper surface of the bottom panel with the distal end of the friction element, welding of the friction element to the bottom panel, and deformation of the friction element during insertion.

13. The method according to claim 12, wherein the exhibiting completion of the at least one key FEW process characteristic is a change in the torque.

14. The method according to claim 13, wherein the RPM of the bit is adjusted in real-time as a function of the change in torque.

15. The method according to claim 14, wherein the applied insertion force on the bit is adjusted in real-time as a function as of the change in torque.

16. A method of installing a friction element, the method comprising:
driving the friction element through at least a top panel and welding the friction element to a bottom panel using a friction element weld (FEW) machine using an electric motor to rotate the friction element at one or more predefined RPMs and a servo-motor to apply one or more axial insertion forces to the friction element;
controlling at least one key FEW controlled parameter of the FEW machine during installation of the friction element, wherein the at least one key FEW controlled parameter is at least one of RPM of the friction element and applied insertion force on the friction element;
monitoring at least one key FEW monitored parameter of the FEW machine during installation of the friction element, wherein the at least one key FEW monitored parameter is at least one of torque of the electric motor rotating the friction element, time during installation of the friction element, energy consumption during installation the friction element, electric current of the electric motor during installation of the friction element, and electric current of the servo-motor during installation of the friction element;
adjusting the at least one key FEW controlled parameter of the FEW machine in real-time as a function of and in response to the at least one key FEW monitored parameter exhibiting completion of at least one key FEW process characteristic such that the friction element is adaptively installed based on the adjusting of the at least one key FEW controlled parameter of the FEW machine; and
generating an alert in response to the at least one key FEW monitored parameter signaling a failure to complete the at least one key FEW process characteristic.

17. The method according to claim 16 further comprising generating an alert in response to the at least one key FEW monitored parameter signaling overfilling of an underhead of the friction element.

18. The method according to claim 17, wherein the at least one key FEW monitored parameter signaling overfilling of an underhead of the friction element comprises a spiked increase in energy consumption during installing of the friction element.

19. A method of installing a friction element, the method comprising:
driving the friction element through at least a top panel and welding the friction element to a bottom panel using a friction element weld (FEW) machine using an electric motor to rotate the friction element at one or more predefined RPMs and a servo-motor to apply one or more axial insertion forces to the friction element;
controlling at least one key FEW controlled parameter of the FEW machine during installation of the friction element, wherein the at least one key FEW controlled parameter is at least one of RPM of the friction element and applied insertion force on the friction element;
monitoring at least one key FEW monitored parameter of the FEW machine during installation of the friction element, wherein the at least one key FEW monitored parameter is at least one of torque of the electric motor rotating the friction element, time during installation of the friction element, energy consumption during installation the friction element, electric current of the electric motor during installation of the friction element, and electric current of the servo-motor during installation of the friction element;
adjusting the at least one key FEW controlled parameter of the FEW machine in real-time as a function of and in response to the at least one key FEW monitored parameter exhibiting completion of at least one key FEW process characteristic such that the friction element is adaptively installed based on the adjusting of the at least one key FEW controlled parameter of the FEW machine;
generating an alert in response to the at least one key FEW monitored parameter signaling a failure to complete the at least one key FEW process characteristic; and
generating an alert in response to the at least one key FEW monitored parameter signaling overfilling of an underhead of the friction element.

20. The method according to claim 19, wherein the at least one key FEW monitored parameter signaling overfilling of an underhead of the friction element comprises a spiked increase in energy consumption during installing of the friction element.
